(19) United States
(12) Patent Application Publication
(10) Pub. No.: US 2022/0353455 A1
(43) Pub. Date: Nov. 3, 2022

(54) Target Tracking Of Motor Vehicles Or Other Moving Objects By Forming An Ad Hoc Network Of Devices

(71) Applicant: CFKK, LLC, Beverly Hills, CA (US)

(72) Inventors: Leonard Kleinrock, Beverly Hills, CA (US); Yu Cao, Hangzhou (CN)

(21) Appl. No.: 17/857,644

(22) Filed: Jul. 5, 2022

Related U.S. Application Data
(63) Continuation-in-part of application No. 16/990,627, filed on Aug. 11, 2020.
Application No. 16/990,627 is a division of application No. 15/226,464, filed on Aug. 2, 2016, now abandoned.
(60) Provisional application No. 62/200,028, filed on Aug. 2, 2015.

(51) Int. Cl. H04N 5/77; H04L 67/12; H04N 7/18; H04N 5/232; H04N 9/82; H04L 67/01

(52) U.S. Cl. CPC H04N 5/77; H04L 67/12; H04N 7/181; H04N 5/23222; H04N 5/23203; H04N 5/23216; H04N 9/8205; H04N 5/23206; H04N 5/23238; H04L 67/01

(57) ABSTRACT

For tracking a target, multiple smart devices are self-organized into an ad hoc network, once a target is detected. A typical target is a motor vehicle or other moving objects. To add a device to the ad hoc network, a device within the system reaches out to a device that is not in the ad hoc network, and solicits the latter for images and data gathered in the past, as well as for future gathering of images and data. The usefulness of a device to the ad hoc network in view of target tracking is calculated, so that devices are added to or removed from the ad hoc network. The network might track multiple targets. In addition to detecting and tracking targets in “real world” scenes, targets in video games, or in virtual worlds, or in the Metaverse, are also contemplated.

This application is a continuation-in-part of U.S. patent application Ser. No. 16/990,627 filed on Aug. 11, 2020, titled “Systems and Methods and Apparatuses for Capturing Concurrent Multiple Perspectives of a Target by Mobile Devices”, which is a divisional of U.S. patent application Ser. No. 15/226,464 filed Aug. 2, 2016, titled “Systems and Methods and Apparatuses for Capturing Concurrent Multiple Perspectives of a Target by Mobile Devices”, which claims priority to U.S. provisional application Ser. No. 62/200,028 filed on Aug. 2, 2015, titled “Methods and Apparatus For A Market For Sensor Data”. U.S. 62/200,028, U.S. Ser. No. 15/226,464, U.S. Ser. No. 16/990,627, and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is target detecting and tracking of motor vehicles or other moving objects, by forming an ad hoc network of devices

### BACKGROUND

The following description includes information that may be useful in understanding the present inventions. It is not an admission that any of the information provided herein is prior art or relevant to the presently claimed inventions, or that any publication specifically or implicitly referenced is prior art.

The number of devices—especially those smart devices that have capabilities in sensing, communication, and computation—deployed is growing exponentially, and they typically have planned-for targets, for examples, CCTV cameras at a road intersection for cars running a red light, a dash-cam in a car for views ahead, LiDARs on a car for objects around.

More than ever, massive amounts of data are collected every moment and in nearly every place. Smart, sensor-laden devices are proliferating around the world, and especially in developed countries. Smartphones are the most obvious example, representative of proliferation of data.

However, when there are targets that are unplanned for, unexpected, unknown in advance to the devices an ad hoc network of devices could be among the few possible means to detect and track the targets in the moment, and then after the fact, the images and data gathered by these devices are the only sources to investigation, among other purposes.

Crucially, current infrastructure and economic deficits mean that this proliferation of smart devices is accompanied by un- and under-utilized sensors. Consumers are purchasing smartphones on a regular schedule, leaving millions of increasingly powerful smart phones largely unused. Simultaneously, rapid increases in computing power is driving the price of new devices such as powerful smartphones down to below USD $40.

Other smart sensor devices are following this same path. Smart watches and other fitness trackers, for example, are beginning the obsolescence cycle in which smart phones have already spent more than a decade.

The example of smartphones and other smart devices is only a fragment of the sensor data that will be generated by the emerging Internet of Things (IoT), in which billions of smart and often sensor-laden devices will be connected to the Internet.

This emerging world of smart devices amidst a broader IoT is taking place amongst an undeniable recognition that there is great utility to the massive collection and processing of sensor and other data. Both corporate and government investments in large-scale infrastructure to this effect are testimonies to this fact. From security to public health, sensor data is an integral part of modern life in the developed and developing world.

It is known in some instances for self-mobilized devices (miniature robots, for example) to autonomously collaborate to achieve some objective. But most IoT sensors (including for example cell phones and wearable electronics) are not self-mobilized. They might well be moved about by a human, or be attached to a motor vehicle, but they cannot move about on their own. There still seems to be no easy way for sensor devices to autonomously collaborate to capture concurrent multiple perspectives of a target.

Further, for self-driving cars (for our purpose, “self-driving car” is synonymous to “autonomous vehicle”, “semi-autonomous vehicle” as in a typical Tesla car circa 2021), there are many sensors on a vehicle thus making it a “smart device that has multiple sensors”.

We do not make a further distinction between “self-mobilized sensor devices” vs “non-self-mobilized sensor devices”.

There are systems in which multiple cameras are arranged by location, and the camera angles, durations and other aspects coordinated by one or more individuals in a control room. Examples include multiple TV cameras situation about a sporting event, but this method does not solve the problem because the collaboration is human driven rather than autonomous.

A “poor man's” alternative system is exemplified by the CamSwarm™ mobile app, which is said to mimic the “bullet time” effect popularized by the 1999 film The Matrix. There, a large number of cell phones or other cameras are positioned in a semi-circle about a target being filmed. Each camera operates independently under the control of a human operator, although each of the human operators is more or less controlled by whomever is coordinating the shoot.

Periscope™ is a more sophisticated system, in which anyone with a cell phone and the Periscope app can live-stream whatever is around them. The system is similar to that described above in that a viewer, nearby or halfway across the world, can make suggestions to the person taking the live stream (what to film, what camera angles, and so forth). iPhone users have had this capability for several years with FaceTime™, which has been used to view homes or autos for sale, to provide images of clothing or other goods to house bound shoppers, etc.

A still more sophisticated system is TapThere™, which is on the market, but has not yet become popularized. TapThere allows viewing individuals to tile multiple views from different live-streaming cameras, which can be selected from potentially thousands of available streams.

Despite the sophistication of Periscope and TapThere, it is still unknown for the smart devices to coordinate among themselves to figure out what target to image, and how to arrange the cameras in an appropriate manner to capture concurrent multiple perspectives of the target. Instead, there is always a human that selects the targets, and either directly or indirectly controls the cameras.

In some embodiments, the numbers expressing quantities of ingredients, properties such as concentration, reaction conditions, and so forth, used to describe and claim certain embodiments of the inventions are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the inventions are approximations, the numerical values set forth in the specific examples are reported as precisely as practicable. The numerical values presented in some embodiments of the inventions may contain certain errors necessarily resulting from the standard deviation found in their respective testing measurements.

As used in the description herein and throughout the claims that follow, the meaning of “a.” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the inventions, and does not pose a limitation on the scope of the inventions otherwise claimed. No language in the specification should be construed as indicating any non-claimed element essential to the practice of the inventions.

Groupings of alternative elements or embodiments of the inventions disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Data, as well as images, could be from before the start of the organizing of the devices, that has been already gathered by a device. Data could also be from after the start of the organization, as in the case of U.S. Ser. No. 10/803,322 “Networks of sensors collaboratively chronicling events of interest”.

As used herein, the term “data” and “image” are considered as synonymous.

In the contemplated context of gathering images and data regarding a target, a piece of data is deemed “valuable” because it is considered as “relevant” to the target. Below, the term “valuable” and “relevant” are considered synonymous.

There are at least the following difficulties in organizing an ad hoc network of devices for the above mentioned purpose. (1) One difficulty is that before being told, a device is not aware of the fact that it might already have data that is deemed valuable by someone else; (2) Another difficulty is that it is impossible to know a priori the complete set of devices that might hold valuable data before an interest is established; (3) A third difficulty is that because the target may be mobile, and the devices may also be mobile and their sensing ranges are limited, it is not readily clear what devices are even in a position to capture, or that have captured, data regarding the target at a particular point of time. (4) There is the question whether a device claiming that it has good data has indeed good data.

Thus, there is a need for systems and methods in which smart devices autonomously collaborate to decide upon (namely, detect) a target, and then capture concurrent multiple perspectives of the target, and/or then track the target.

It is also advantageous to obtain images and data from many devices, which are organized in an ad hoc way to provide images and data in reference to a target that was not detected before the start of the organizing of the devices.

### SUMMARY OF THE INVENTION

The inventive subject matter provides apparatus, systems and methods in which devices autonomously collaborate in an ad hoc way, to decide upon (namely, detect) a target, and then track the target by capturing data of the target from past and in future, therefore serving purposes such as using collected concurrent multiple perspectives of the target in investigation. The devices are said of forming an ad hoc network for the purpose of detecting and tracking the target. Detecting and tracking is partially aided by performing image analysis on the gathered images and data.

Consider the case of gathering sensing data for a boxing practice session. The session is divided into two periods. During the first period, a boxer (“boxer X”) is coached by a coach, and during the second period, boxer X has a bout with the second boxer (“boxer Y”). For beneficial effects, sensing data including images, videos, audios, and limb movements are gathered. Multiple sensing devices work together to do the gathering. A stationery camera (“device A”) stands by on premise. When certain conditions are met, device A starts video recording, such met conditions include: a specific time has arrived, a motion is detected by a motion detector attached to device A, or a human pushes a button on device A. In order to have additional perspectives and additional data during the session, the coach uses a mobile phone (“device B”) that captures video and audio of boxer X. Both boxer X and boxer Y have wearable sensing devices (“device C” and “device D” respectively) that capture their limb movements. At the end of the session, data from all devices are submitted to a collector. The data can then further processed and rendered.

A target is located, recognized, or followed (tracked) by an ad hoc network of smart devices, and the target that is tracked or detected can be either stationary or moving with respect to the ad hoc network.

Contemplated such a target could be (1) a motor vehicle, (2) a car going in a wrong direction, (3) a moving car whose driver is observed dozing off at the wheel, (4) a human-driven car changing lane carelessly among neighboring self-driving cars, (5) a car that is observed having a flat tire, (6) a car that is observed to have failed to stop fully at a stop sign, (7) other moving objects such as drones, walking pedestrians; (8) a one-car wreck, (9) a multiple-car incident.

Further considered a target is an intruder on the perimeter of a relatively large area such as a ranch, a factory, an airport.

Also considered are targets in virtual worlds in a Metaverse. For example, a target could be an area where trucks and drones go in and out, and the need is to tracking the number of trucks and drones inside the area.

In contemplated scenarios, many devices may contribute to the detecting and tracking of the target. However, in many contemplated scenarios, devices are not previously tasked specifically for tracking the target in question; therefore these devices are organized in an ad hoc way for the purpose of detecting and tracking the target or targets.

The term “ad hoc”, according to the online Collins dictionary, is defined as: “An ad hoc activity or organization is done or formed only because a situation has made it necessary and is not planned in advance”.

With the contemplated ad hoc network of devices, before a target is detected, the devices are not tasked specifically to detecting or tracking the target; once the target is detected, a number of devices are engaged so as to contributing to the tracking of the target, therefore they form an ad hoc network. Hence, before the target is detected, the membership of the network is not known; namely, the number of the devices is not known, what devices are not known, either. At the moment of the target is detected, the ad hoc network contains one device, and this device attempts to expand the network. In due course, more devices join the network. This unfolds while there is no an a priori plan with which what devices will be joining the ad hoc network over time.

These thusly organized devices provide images, sensory data, and other data that are helpful to detecting or tracking the target, it is in this sense that these devices form an ad hoc network.

In the contemplated use cases, a target is “not planned in advance” to the ad hoc network, in that there is no prior knowledge when, or where, or what kind of, a target will be first detected by a device. In contrast, for example, an observatory's telescopes “plans for” a particular star at a particular hour in a particular sky region. In another contrasting example, an air defense system “plans for” particular types of incoming targets.

A source of the unplanned nature is that some of the devices are mobile, for example, a dash cam in a moving car; thus there is no prior knowledge where a target will be detected.

Further, another source of the unplanned nature, or “unexpectedness”, is the number of targets that the ad hoc network will eventually track. In contemplated use cases, an ad hoc network starts tracking one target, then over time at some point, may start to track a second target.

In addition, there is no prior knowledge that which device in the ad hoc network of devices, will be the first to detect the target.

The contemplated technical solution manages an ad hoc network of devices. A first device detects a target, therefore becoming the first member of the network. In order to gain more images and data for the purpose of tracking the target, the first member of the network tries to expand the network by soliciting a second device. The decision of the solicitation considers to what extent a second device is useful in tracking the target, and factors contributing to the usefulness include but are not limited to the second device's already gathered images and data, whether these images and data are relevant to the target, and also to what extent the second device will be able to contribute relevant images and data in future tracking of the target. The ad hoc network is further expanded by either the first device or the second device soliciting a third device, and so on.

To assess the goodness of managing the ad hoc network, one criterion is “recall” (a terminology borrowed from the field of Information Retrieval), as in if it can be known there are P devices that have data of value, how many of the P devices that the solution can find? Another criterion is “precision” (also a terminology borrowed from the field of Information Retrieval), that in the Q devices that are indeed found, how many of them do have data that are of relevance.

With aspects of the current inventive subject matter, the scenario above is enhanced so that collaborative gathering with amounts of autonomy is deployed in collecting concurrent, multiple perspectives of the session. Device A is mounted in guide rails near the arena, and the starting of recording is determined as describe above, namely when a certain condition is met, or a human commands the device. During the first period of the session, device A, being networked with device B, solicits device B to record the session. Device B being carried by a person has more leeway in choosing a location and angle when conducting video recording and audio recording. Device B, which happens to be a mobile phone, contains software which provides advice on moving in relation to the center of the arena. In one conceived embodiment, the software gets real-time images that is gathering by device A, compares the images from device A and images from device B itself, and calculates needed movement of device B, so that a quality measure that is partially based on the images from device A and the images from device B is improved. Meanwhile, device A receives advice from device B so that device A moves along the guide rail. Further, device C and device D are solicited by device A so that limb movements of boxer X and boxer Y are sensed, and data gathered in time. Device C and device D and advised by device A during the session so that limb movements are gathering at changing resolutions so as to balance storage, battery, data quality for device C and device D.

In preferred embodiments, at least one of the devices obtains information. The information can be obtained in any suitable manner, including for example from a human user, or a non-human source, such as a sensor on the information obtaining device. The information can be a condition to be met, for example, a schedule time has arrived, for another example, a device has moved into an area. The information can also be the desire to capture sensing data. The device then uses the information to commence a session of data gathering relative to a target, which in preferred embodiment refers to an object, an event, or a scene. That device or a server electronically networked with the device, then solicits other devices to collaborate in capturing the other perspectives of the target. To facilitate such collaboration, the mobile devices in preferred embodiments are organized so that from time to time each device notifies a server of its then-current availability, capability, and location.

One very important aspect of the inventive subject matter is that “collaborative gathering” of data is carried out by devices where spatial mobility is being controlled by a human. Thus, a cell phone is included as a mobile device herein when someone is carrying it around on his/her person. Similarly, a DLSR camera can be a mobile device herein when it is being carried about by a human, positioned on the dashboard of an automobile being driven about by a human, or for example when the camera is being positioned on a slider or dolly. As yet another example, a flying drone is included as a mobile device of the inventive subject matter when its spatial movements are being are controlled by a human On the other hand, devices of the inventive subject matter exclude self-mobilizing robots, e.g., Gizmodo™, BigDog™, Asimo™, and auto swarming robots, when decisions regarding movements of the robots are being made entirely under their own control.

In some contemplated embodiments, at least one of the various contacting and contacted devices is either a cell phone or some other electronic device having a telephony (voice transmitting and receiving) capability.

During a typical session, contemplated collaborative gathering of devices involves at least two aspects. One aspect is the spatial aspect. The gathering could be about an object, or multiple objects across a scene, or multiple objects across a large area. The other aspect is the temporal aspect, in which an event unfolds. The gathering, however, doesn't necessarily arise to recognition. For example, during a session a device gathers audio that contains barking and talking, but the device is not aware of the fact that the session contains dogs and humans.

The collaboration is particularly important to improve the quality of gathered data. Consider a session where device A takes pictures of a person. A second device (“device B”), an audio recording device, can collaborate, and gather the perspective of the person's talking. Thus, pictures from device A and audios from device B, together improve the quality of the gathered data on the person during the session. Now consider that device C, a mobile phone, is solicited, upon which device C gathers video from an additional perspective of the person in an angle and distance different from those of device A. Thus, pictures from device A, audios from device B and videos from device C supply different perspectives and together improve the quality of the gathered data.

An underlying principle of the contemplated systems, methods and apparatuses is dynamic resource sharing, namely, that in the prior art, the mass of computational power, network resources, and potential sensor data is largely unused, and that the inventive subject matter described herein will permit dynamic sharing of those resources.

In a typical embodiment, a commencing device, described herein as device A, commences a session, and solicits device B to help. Device B in turn can solicit another device, thus forming a solicitation cascade. At least one of these other devices agrees to these solicitations, and provides its/their perspective(s) of the target. There are numerous six contemplated permutations for each solicited device. A solicited device could (1) actively or passively agree to provide a perspective, or (2) actively or passively decline to provide a perspective, and in each case either solicit or not solicit another device to participate. In any event, it is contemplated that the actions of the various contacting and contacted devices can be autonomous, i.e., the devices might or might not be subject to full control by another of the devices.

Contacting of the other devices can be accomplished in any suitable manner, and either substantially concurrently (real time or near real time), or asynchronously. Thus device A might contact device B, and then 1, 2, 5, 10 minutes later (or with some other lag) contact device C. It is also contemplated that the contacting could be done by a server other than one of the perspective providing devices.

Irrespective of when the other devices are contacted to provide their additional perspectives, the various solicited mobile devices can provide their information to the collector concurrently, or in any suitable sequence or time frame. For example, it is contemplated that a dash cam on an automobile might “see” a car accident, and solicit additional perspectives from dash cams in nearby automobiles. The various perspectives from the other dash cams can then be received by a collector, and then mosaicked by the collector or some other device. In another example, a cell phone being used by a participant in a birthday party might “see” someone blowing out a birthday cake, and solicit additional perspectives from nearby cell phones. Such solicitation might be initiated by the user of the soliciting cell phone, or might be initiated by the soliciting cell phone autonomously from its human user. As in the other example, the various perspectives from the various cell phones could then be received by a collector, and then mosaicked, stitched together in a 3D virtual reality image, or combined in some other manner by the collector or some other device.

Besides just soliciting additional perspectives from other devices, the soliciting device can have other interactions with the other devices. For example, solicited device B might advise a different solicited device, device C, that device B has agreed to provide an additional perspective. Or that device B has declined to provide an additional perspective. Similarly, one or more of the various devices, or the server or collector, might communicate with one or more other devices to change angle, distance, or other aspect of their perspective(s). As another example, one or more of the various devices, or the server or collector, might communicate with one or more other devices to provide information about funds that can be earned by providing their additional perspectives, or perhaps to negotiate a fee. As yet another example, device A advises device B on the value of the data on device B, for example, device A might advise device B that the past M seconds of video that has been captured by device B is valuable judged by device A, and the future N seconds of video will also be valuable. As a further example, device A advises device B that at a future time, device B should be present at a certain location and capture audio data of the surroundings.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a flowchart depicting contemplated steps of the method for devices collaborating.

FIG. 2 is a collection of representations of some contemplated targets.

FIG. 3 is a schematic showing spatial relationships among multiple devices A, B, C, and D, a server, and two targets.

FIG. 4 is a table listing capacities of at least one of the devices of FIG. 1.

FIG. 5 is a flowchart depicting a contemplated series of collaborative interactions between device A and at least another of the devices of FIG. 1.

FIG. 6 is a flowchart depicting contemplated steps in managing problems associated with availability of devices B, C of FIG. 1.

FIG. 7 is a flowchart depicting contemplated steps in managing problems associated with capacities of devices A and B of FIG. 1.

FIG. 8 is a flowchart depicting contemplated steps in networking devices A and B of FIG. 1.

FIG. 9 is a flowchart depicting contemplated steps in processing data at the collector of FIG. 1.

### DETAILED DESCRIPTION

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

One should appreciate that the technical effects include software: (1) that contains a human-machine interface with various settings so that humans can provide information to devices; (2) that enables a soliciting device to distinguish “interesting” events, situations, objects, scenes, time intervals, spatial areas that warrant soliciting other devices to provide additional perspectives, from non-interesting ones; (3) that autonomously enables the soliciting device to identify and solicit various mobile devices; (4) that advises a solicited device how to provide their own additional perspectives, for example, to advise a device which direction to point to, how long the audio recording should last; (5) that includes mobile apps installed on phones; (6) that manages scarcity in a device's capacities in communication, storage, battery life, and mobility; (7) that manages the transmission of data between a device and a server and (8) that works with the server and a collector, for example, an interface for querying the gathered data.

Such software could be completely or partially resident on a device, or completely or partially resident on a different device, or completely or partially resident on the server, or completely or partially resident on the collector.

One should also appreciate that the technical effects include combining such software with hardware, so that making middleware and/or microchips.

One should further appreciate that the technical effects include a piece of hardware, preferably in the form of a dongle, that is to be combined with a second piece of hardware which is coupled with a sensing device, examples of such coupling include a selfie stick for mobile phone, a slider-dolly for camera, a guide wire for a mini-camera to be inserted into human body. The combination provides autonomous mobility to sensing devices. During a session of gathering sensing data, the dongle with its built-in computation and communication capabilities comes up with instructions to the second piece of hardware which moves a sensing device for good quality of gathered data.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Within an ad hoc network of devices, a device collects images and other data. In preparatory steps, image analysis is performed in order to obtain meta-data and other information. Image analysis is defined as a systematic operation or series of operations performed on data representative of an observed image with the aim of measuring a characteristic of the image, detecting variations and structure in the image, or transforming the image in a way that facilitates its interpretation.

Some of the metadata of an image are created using image analysis. For example, often it is through image analysis that locating and registering the image relative to a device or stored prototype is accomplished. Pre-processing, an optional step, creates metadata and data content from a piece of data. Typically metadata is of small size, especially compared with “data content”. For example, from the data of an image, there could be created the metadata of the location, the maker of the camera, the timestamp, and the “data content” of pixels of the image. When finding relevant device data, the system will combine locally produced metadata with other attributes suggested by the local device's user, as well as what it can infer from its own analysis of the data and that of nearby devices.

Additional methods may also be employed to create additional metadata.

Further, metadata of a sensor, of a device, is also made available. The metadata may includes a series of its positions and time, [x,y,z,t]; in addition, metadata may include a camera's direction, pan, zoom, tilt, as well as what other sensors may exist on the device. In the case where a sensor is on a moving object such as a car or a plane or a drone, the meta-data of the moving object is made available, too.

Similarly, the metadata of a target, including but not limited to, the [x,y,z,t] coordinates and time, velocity, acceleration, its size (for example, a target might be a building, a construction site, a large truck) is made available, not unlike the metadata of a sensor, or the metadata of a device.

The history of metadata is also made available.

In a contemplated solution, given a target that has been detected, a relevance score is assessed for a piece of data. In the assessment, the following considerations are given:

(1) The target's representation includes but is not limited to an image, a pattern, a set of metadata, a history of metadata.

(2) Calculate a relevance score of the data to the target's representation. Any number of similarity measurements, such as Sum of the Squared Differences, the Cosine Similarity, may be used. Further, portions of data can be compared, using methods such as OpenCV's template matching.

(3) If the data contains an image, calculate a relevance score of the image to the target's pattern. First, image analysis is performed on the image so that a pattern is discerned; and then this pattern is compared with the target's pattern.

(4) Calculate a relevance score based on a set of metadata of the data and the metadata of the target. One important outcome is to answer whether the data and the target overlap in time and space. Further, based on the history of the metadata of the target, predict the target's future space-time trajectory, and calculate the relevance based on the data's metadata, and the predicted future space-time trajectory of the target.

(5) Calculate a relevance score based on data that are known to be of high relevance score. Over time, one or more pieces of data are known to be of high relevance score to the target. Thus, the data currently in question is compared with those data, the comparison may be done in any of the suitable methods such as similarity measures, template matching.

(6) The several types of relevance scores above are combined in a final relevance score; the combining may be accomplished in any a suitable way, such as a weighted sum, a decision tree.

Given the need for tracking a target, and given an ad hoc network at a certain moment, the usefulness of a device is assessed in the context of the ad hoc network that may add or remove devices over time.

In the assessment of the usefulness, the following are considered.

(A) Calculate a usefulness score based on the metadata of the device and the metadata of the target. An important outcome is to answer whether the device and the target overlap in time and space. Further, based on the history of the metadata of the target, the target's future space-time trajectory is predicted, and the relevance based on the device's metadata, and the predicted future space-time trajectory of the target is calculated.

(B) Calculate a usefulness score of the device's past data to the target. For each piece of the data that the device has already gathered, calculate a relevance score of the data to the target. The calculation may utilize the “calculate a relevance score of the data to the target's” described elsewhere in this document. The usefulness score is derived from the relevance scores, the derivation may use weighed summation, a decision tree.

(C) Calculate a usefulness score based on the device's anticipated future images to the target. For each such an image, a relevance score is calculated, which may utilize the steps of “given a target that has been detected, a relevance score is assessed for a piece of data” described elsewhere. The usefulness score is derived from the relevance scores, the derivation may use weighed summation, a decision tree.

(D) The several types of usefulness scores above are combined into an overall usefulness score, the combining may be accomplished in any a suitable way, such as a weighted sum, a decision tree.

In calculating the relevance scores as well as the usefulness scores, machine learning methods may be employed in finding similarities between images, in classifying patterns contained in images, among other computational tasks.

A contemplated method for managing the ad hoc network for the purpose of target tracking is as follows.

Step 1, a device, Device A, detects an object, an event, a behavior, and the object/event/behavior is understood to be a target; for detecting and tracking the target a network of devices is to be created in an ad hoc manner.

The detection of the target can be accomplished in any suitable manners. One type of manners is using prior knowledge, for example, a piece of gathered data is compared to a pattern known to the device, and if the data and the pattern have enough extent of matching, a detection is achieved. Another type of manners does not use prior knowledge. For example, two pieces of the gathered data is calculated their difference, and when the difference is large enough, a detection is achieved.

Step 2, Device A reaches out to another device, Device B; and the usefulness of Device B to the target is assessed. In the assessment, the data that Device B has previously been gathered are considered, so do data might be gathered in future are considered. If the usefulness of Device B exceeds a “usefulness threshold”, Device B is considered as a new member to the ad hoc network. The assessment may be carried out by Device A or Device B; it is also contemplated that the assessment is carried out by a computer server that is able to communicate with Device A or Device B. And repeat.

Step 3, Device B may reach out to at least one another device. And repeat.

Step 4, the usefulness of every device to the target is assessed. If a device's usefulness becomes below a threshold, the device is no longer a member of the ad hoc network.

Step 5, the ad hoc network finishes when no device is useful any longer.

Note in Step 2, after reaching out to Device B, Device A might immediately reach out to yet another device, Device C. Therefore in Step 3, Device B reaches out to another device which could happen to also be Device C.

An ad hoc network may detect and track two or more targets. In the course of detecting and tracking a target, the following may happen so that a second target is detected and tracked by the ad hoc network:

(i) Detection of a second target. (i-1) The target is detected by a current member of the ad hoc network; (i-2) The target is detected by an outsider device which in turn successfully solicits a member of the current ad hoc network, thus the outsider device becomes a member of the ad hoc network.

(ii) Tracking of the second target. A device may be solicited to preserve past data regarding both targets or just the second target. A device may also be solicited to gather data regarding both targets or just the second target in future.

While the contemplated methods are deployed in many scenarios that are “real” scenes such as cars, people, it is further contemplated these methods can be deployed in scenarios in those “virtual worlds” in today's Metaverse.

In a contemplated scenario, a 3D model of a construction site is an target. Device A happens to be the LiDAR on an iPhone® 13, and it does scanning, and makes its scanned results available for 3D modeling. Because Device A is not able to scan the entire construction site, it reaches out to Device B, which happens to be a portal 3D scanner (for example, a product from Revopoint 3D® company). Device B has past data on one part of the construction site, and is expected to be useful in future gathering of data, therefore Device B adds itself to the ad hoc network formed by the ad hoc network of the devices. Device B reaches out to Device C, which happens to be a LiDAR device installed a few feet above the construction site thus having a perspective that is rare, thus the usefulness of Device C is above a threshold, and Device C adds to the ad hoc network which by now consists of three devices.

In still another contemplated scenario which occurs in a virtual world in a Metaverse, a first user needs to tracking the number of trucks and drones in a given region, but the user does not have a bird's-eye view of the region. In the virtual world, each user has a software agent that detects and tracks movements of trucks and drones. The user's software agent, understood as Device A in the contemplated implementation, detects and tracks a number of trucks and drones going in and out of one part of the perimeter of the region. Device A reaches out to other software agents. Device B, which is a software agent of another user, is assessed its usefulness in detecting and tracking trucks and drones in and out of another part of the perimeter, and the usefulness is above a threshold, so that Device B becomes part of the ad hoc network of devices Further, Device B reaches out to Device C, which is assessed as being useful enough, and joins the ad hoc network. With the method, the first user is able to detect and track the target, as in the status of trucks and drones inside the region, using the ad hoc network of devices.

Once a device that is in the position of either already having useful images/data, or is in the position of gathering further data, there is the question how the device can utilize its limited resources, such as storage, and communication bandwidth (and battery), so that the device can increase its contribution to data regarding a target, or a few targets.

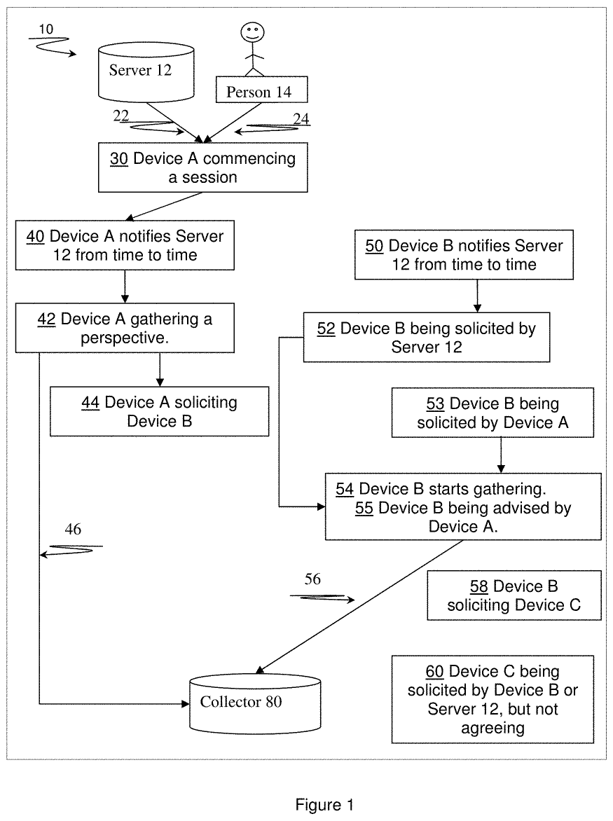

FIG. 1 is a flowchart depicting further contemplated steps of the methods for devices collaborating. With method 10, a server 12 at step 22 gives information to device A; alternatively, person 14 at step 24 gives information to device A. Information can be obtained in any suitable manner, including for example from a human user, or a non-human source, such as a device on the information obtaining device. The information can be a condition to be met, for example, a schedule time has arrived, or as another example, device A has moved into a specific area. The information can also be an indicator that something interesting has happened. At step 30, device A starts a session of data gathering, the gathering being for an object, an event, or a scene, as suggested by the information received.

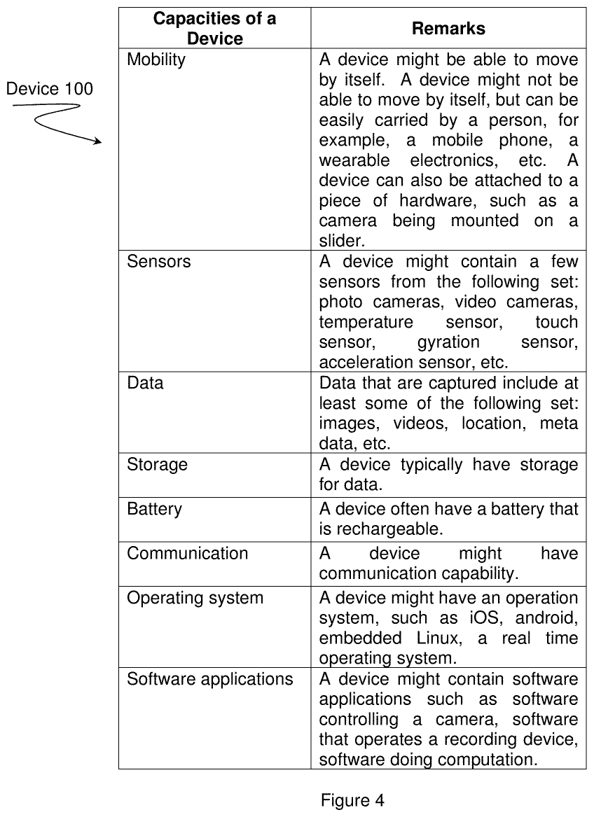

At step 40, device A from time to time informs its location, availability, and capabilities to server 12. Similarly at step 50, device B does the same. The devices and server are networked, so that information on location, availability, and capabilities of devices can be transmitted to the server. The server in turn transmits the information of a device to other devices. In FIG. 4, more on the location, availability, and capabilities of a device is depicted.

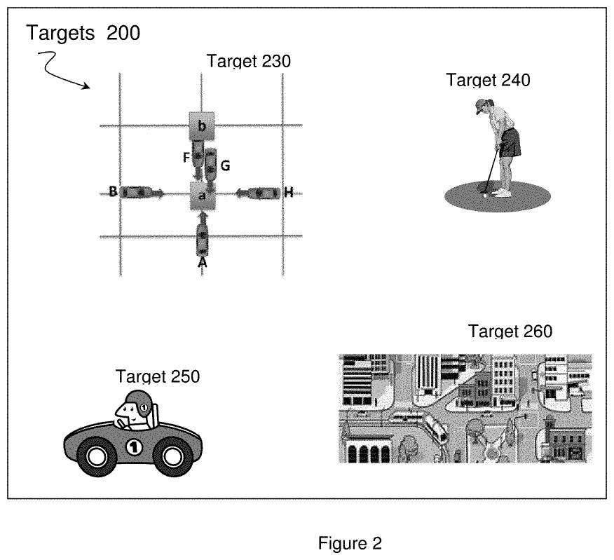

At step 42, device A gathers sensing data, such data forms a perspective of what is being captured. At step 54, device B also gathers sensing data, providing an additional perspective. In FIG. 2, more on the perspectives is depicted.

Device A by either peer-to-peer communication, or through a server, finds out whether there are at least one device (referred to as device B without loss of generality) that can help, based on the known availability, capability, and location. Once solicited by device A, device B chooses to help for the next during of time. It is also determined by device A or the server that device B indeed is able to provide perspectives in addition to those that can be captured by device A.

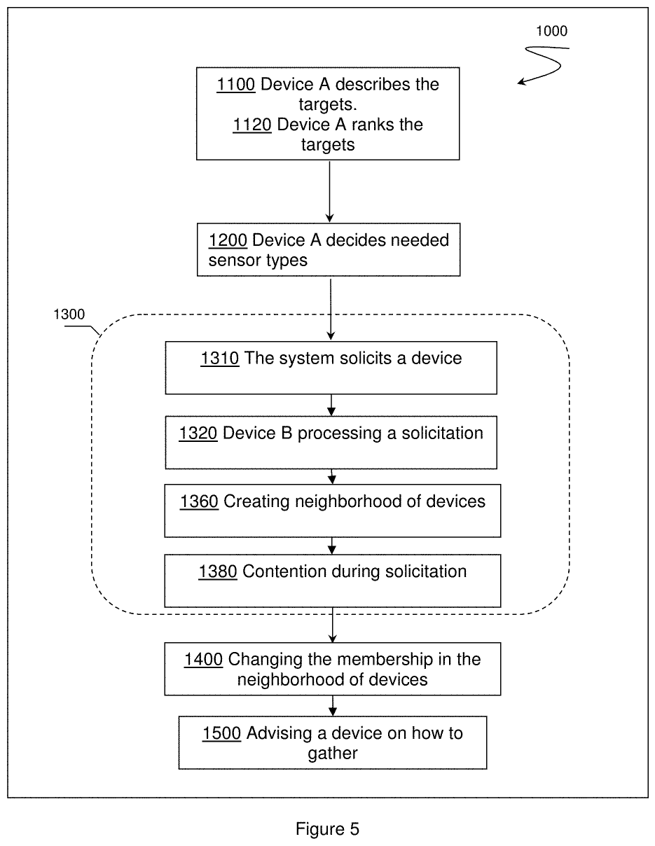

Specifically, at step 44, device A has been made aware of the availability of device B, and device A solicits device B to start gathering sending data, thus providing additional perspective. The solicitation can be sent directly from device A to device B, or alternatively, the solicitation is sent from device A to server 12, which in turn sends it to device B. At step 53, device B receives the solicitation from device A. Further, server 12 can by itself initiate a solicitation that solicits device B, thus at step 52, device B receives server 12's solicitation. Either through step 52 or step 53, device B receives a solicitation, and at step 54, device B agrees to the solicitation, and starts gathering data. While device B is gathering data, it becomes aware of device C, and at step 58 device B solicits device C. At step 60, device C receives the solicitation from device B, but does not agree to the solicitation. More on solicitations among the devices and the server is depicted in FIG. 5.

At step 55, device B is being advised by device A on gathering, in order for device B to achieve good quality in providing the additional perspective. Such advice broadly falls into the category of location, settings for sensing, and utilization of capabilities; a piece of advice could be moving to another location, panning the camera, pointing the camera to certain directions, changing settings of audio recording, among other possibilities.

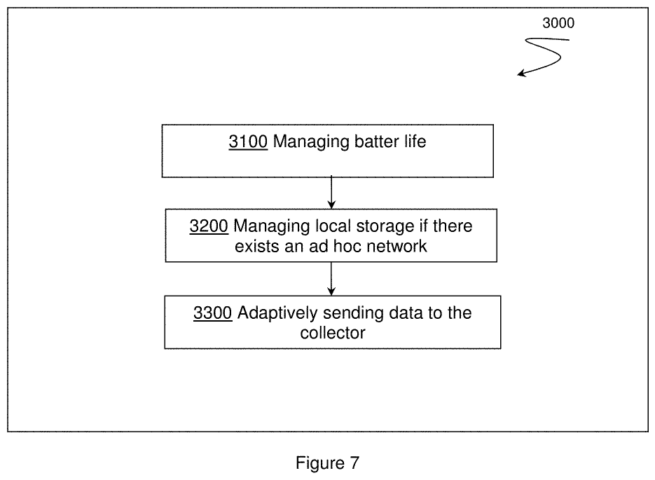

At step 46 and step 56, device A and device B respectively provide their perspectives to collector 80. Such providing can be done through streaming, or alternatively, by transmitting data at appropriate time so that bandwidth is used economically. Such management is further depicted in FIG. 7.

FIG. 2 is a depiction of different kinds of targets. As used herein, the term “target” refers to an object, an event, or a scene, from which sensed data can be collected, and of which data can be observed from multiple perspectives. For example, contemplated targets include animate objects of all kinds, including for example people or other animals, and inanimate objects of all kinds, including for example very large structures such as galaxies and stars, mountains, bridges or buildings, and a street intersection, smaller objects such as automobiles, bicycles, telephones, speakers, printers, birthday cakes, furniture, and even much smaller objects such as grains of sand, dust particles, atoms and molecules which are visualizable through a microscope. To demonstrate the wide breadth of contemplated types of targets, a target could be a changing scene at a street intersection (i.e. a defined environment), or a mobile or immobile object, such as a vehicle or building, respectively. As other examples, the target could be a car involved in an on-going accident, a celebrity spotted in a street, a person's leg being monitored for sweating by microchips, or a fire being monitored by a number of drones plus a number of CCTV cameras.

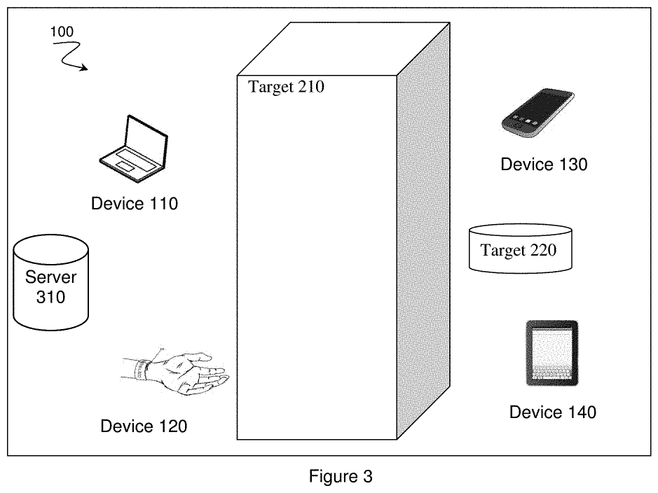

FIG. 3 is a schematic showing spatial relationships among multiple devices A, B, C, and D with a server. In system 100, several devices are capable of communicating with each other and with the server, every device having at least one sensing capability. A goal is to capture concurrent, multiple perspectives of target 210. Another goal is to do the same for target 220. Target 210 is relatively much larger than a device, to the point that a device, given its relative location to target 210, cannot sense the entirety of target 210. On the contrary, target 220 is compatible with at least one device, so that the device can sense the entirety of target 220.

As used herein the term “multiple perspectives” is used in a broad sense to include different visual angles, different distances, different time frames, different frequencies, multiple objects, changing membership of a set of objects, and an event such as a conference, a concert, changing scenes of a city block, a person's life events across a period of time.

In contemplated scenarios, an ad hoc network consisting of multiple devices performs target tracking or detecting. In target tracking, an object is located, recognized, or followed (tracked) by the ad hoc network. The object may be either stationary or moving with respect to the ad hoc network. The types of objects include, but are not limited to, planes, military vehicles, stars, and similar pattern.

It is further contemplated that the images analyzed and processed herein may be images and data that are representative of a scene in virtual environments such as those find in a Metaverse, or a scene in a flight simulator. While such images are generated by computers, these images are deemed by users as images of people, places, and things, therefore to the users, these images represent actual scenes.

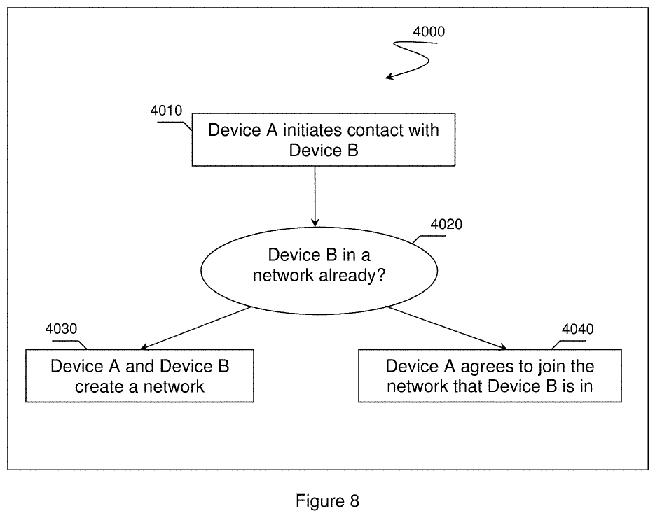

It should be appreciated that reference to four particular devices A, B, C and D in the claims and elsewhere in this application refers to any set of at least four devices coupled together in an ad-hoc network. The designation “ad-hoc” is intended to distinguish the networked devices of the claims herein from devices that are usually coupled together, as for example in a hardwired surveillance system of a factory. More is depicted on forming the ad hoc network in FIG. 8.

It should be appreciated that a typical device has an owner, and owners might agree, a priori, to enter into financial transactions regarding the devices' data gathering as well as the data that have been gathered.

In one preferred embodiment, a mobile phone is mounted on the dashboard of a moving car, and at some point, a person pushes a button on the mobile phone, and the phone starts recording video of the road ahead. Upon seeing an event of interest, the person pushes another button, and a solicitation is sent to the server. The server in time finds a pedestrian nearby holding a phone, and solicits the person to gather video using the phone for a period of time. Data gathered by both phones are sent to a collector.

In one preferred embodiment dubbed “sticks for 3D selfies”, a person holds 2 contemplated selfie sticks, each stick has a mobile phone mounted. A stick has a slider, and the mounted phone can move along the slider. The stick also is couple with a software application, thus is able to communicate with the phone to receive instructions on sliding motions. The person provides information to the first phone, which commences a session of taking of photos of the person. The first phone solicits the second phone, which agrees to the solicitation and starts taking photos. The first phone advises the second phone on moving for certain amounts of distance, and the second phone instructs the slider on its stick to move the distance. After a period of time, the gathering of data is done, and the second phone sends photos to the first phone which acts at a collector.

In another embodiment, a soldier behind a dirt wall is having a firefight with enemies. On the dirt wall there are two guns, each mounted on a slider, and a video camera that is mounted on a tripod. The solider gives information to the camera, so that the camera starts gathering video. The camera from time to time gives the two sliders instructions on how to move so that the guns are more effective in where to shoot.

In one contemplated embodiment, a mini-camera with a guide wire is inserted into a human blood vessel, the camera providing near real-time ultrasound images (Reference: “Single-chip CMUT-on-CMOS front-end system for real-time volumetric IVUS and ICE imaging”), and there is also an optical imaging device that works on the skin of a human. A person gives information to the optical imaging device, and it commences the gathering of images. During a session, the optical imaging device solicits the mini-camera, and the mini-camera agrees to the solicitation, and provides perspectives inside a blood vessel. The optical imaging device on the skin further advises the mini-camera where to go inside the vessel.

In one embodiment, with the game Pokémon GO™, upon its initial release, each player is independent except for the case of teams in gyms; even in gyms, there is no “cooperative” action, but rather each player is “on his own” using his/her Pokémons to do battle in the gym or to shoot at the Pokémon outside the gym. So with the contemplated system, suppose a player is in MacDonald's and she is trying to capture a Pokémon. She can send out a solicitation to some other players in the same MacDonald's™ who agree to join her in forming what we call a “pack” to capture the Pokémon. If one's pack is successful, one somehow shares that Pokémon, probably in some kind of fractional split based on how much one participated in capturing the Pokémon.

FIG. 4 lists capacities and other features of the device.

For the purpose of the contemplated systems and methods, a “smart device”, a “sensor device”, a “sensing device”, a “mobile device”, a “device” are considered synonymous. Below are examples of some but not all attributes that a device might have.

A device might have communication capacities, for example: wi-fi, Near Field Communication, wireless networks (3G, 4G, 5G, 6G, etc.), WiMAX, Bluetooth, CDMA, TDMA, GSM, GPRS, ZigBee, power line communication, etc.

A device may be equipped with one or more sensors. It has been contemplated a catalog of types of sensors, the catalog includes but is not limited to: (1) all sensors that fall under the category of the Internet of Things (see Wikipedia pate on “Internet of Things”), (2) “dumb” sensors, (3) angular position sensors, (4) sensors for position sensing, (5) sensors for angle sensing, (6) cameras and video cameras, (7) infrared sensors, (8) motion sensors, (9) gyros, (10) accelerometers, (11) magnetometers, (12) Geiger counters, (13) seismometer, (14) the Light Detection And Ranging (LIDAR) sensor; (15) heart-rate sensor; (16) blood pressure sensor, (17) body temperature sensor, (18) temperature sensor, (19) velocity sensor.

It has been contemplated a catalog of devices includes but is not limited to: mobile phones, PCs, “android PCs”, drones, airplanes, wearable devices, video cameras such as CCTV and GoPro™, Lab-on-a-Chip (LOC), dash cams, body cams, motor vehicles, and other moving objects.

It has been contemplated a catalog of the environments for a sensor, the catalog includes but is not limited to: underground, in the air, outer space, a moving person/mammal/insect/car, robots, inside a biological body. (Quoting Abundance by Peter Diamandis, “humans will begin incorporating these technologies into our bodies: neuroprosthetics to augment cognition; nanobots to repair the ravages of disease; bionic hearts to stave off decrepitude”).

It has been contemplated a catalog of the “viewsights”/“fieldviews”, the catalog includes but is not limited to: (1) a bird's eyes' view: e.g., CCTV's view, e.g. that of a factory floor, that of an intersection of roads, that of a parking lot, that of a driveway of a home, a large portion of a city, a shipping route, a patrol area, (2) the view by a panorama camera, (3) the view by a “ball, 360-degree” camera, (4) a line in the 4 dimensional space: e.g., data captured by Fitbit™, which is largely the movement on the ground of a dot over time, (5) the view by a nano-sensor, (6) the view by a gastro scope, (7) the view by GoPro mounted on someone's head, (8) the view by a telescope, (9) the view by geo-stationary satellites, (10) the view by crowd-funded micro-satellites.

A note on the sensors: sometimes a sensor has also “actuators”. Consider a video camera. While its main sensor is about capturing video images, there are “actuators” that control the pan, zoom, and other actions.

A device is preferably having computation capabilities. A device might be installed software applications, such as a mobile app, software that controls a camera, software that operates a recording device, software that does computation, and software that manages the device's storage.

A device often has storage that is local to it, thus it is capable of storing certain amounts of data.

A device often has a battery that is rechargeable. When unplugged, the battery has limitation in supply power, and sometimes, when battery is low, the device's capabilities deteriorate.

A device might also contain an operating system, which could be any from the following set: iOS™, Android™, embedded Linux, a real-time operating system.

In one preferred embodiment, a device is sometimes mobile but cannot move by itself. As used herein, the term “mobile device” means something other than a self-mobilizing robot as current typified by products such as Gizmodo, BigDog, and Asimo. As used herein mobile device can mean “hand carryable electronics having a visual sensor, and wireless network communication capability”, including for example a cell phone. Such a hand carryable weighs less than 20 lbs. Mobile device also means “flying electronics having has a visual sensor, and wireless network communication capability”, including for example a drone. Mobile device also means “wearable electronics having a sensor, and wireless network communication capability”, including for example an Apple watch, for another example a microchip implanted into the muscle.

Mobility is also provided by hardware that is attached to the device, for example, a slider-dolly provides mobility to a DSLR camera, for another example, a guide wire provides mobility to a mini-camera that goes inside a human's blood vessel.

It has been contemplated the range of data types available through system, the range includes but is not limited to: A sensor operates at a particular segment of the “scale of the universe”. While several prominent embodiments of the inventive subject matter are concerned with scales of the human body, objects that humans handle, the cities, the atmosphere, the oceans, and the continents, it is also true that scales smaller and larger are of relevance to the inventions, 10⁻⁹ meter gets us past DNA to around a water molecule; 10⁹ meters is a larger field than the Earth and thus covers whatever satellite data. In terms of understanding “events,” this range might actually put us in the business of “phenomena.” [Reference: The Scale of the Universe: Zoom from the edge of the universe to the quantum foam of spacetime and learn the scale of things along the way]

The term “data” means at least the following: metadata, data content, captured data, submitted data, the outputs from various types of processing performed. It has been contemplated a catalog of captured data and submitted data, the catalog includes many types of data as follows, but is not limited to the following: (1) Video, audio, scanned (and recognized, tagged) images, photos; (2) Smell, touch, pressure, temperatures, humidity, gestures; (3) Fluid flow, air flow; (4) Data at existing sites or owned by government agencies or other institutions. Many government agencies own a lot of data that can be made available to the public. Such agencies and the data they own include but are not limited to geographic information on underground water, underground pipes (e.g., pipes beneath a city), oceanic data, weather, data captured by CCTV (closed-circuit Television) monitors, crime reports, and a vast array of epidemiological data published by national health and other research organizations. Also many sites house a lot of data generated by the public. Such sites and the data on the sites include but are not limited to Yahoo Flickr™ YouTube™ Instagram™, Facebook™, and Twitter™. Further, any large enterprises own a lot of data. Such enterprises and their data include but are not limited to oil fields (e.g., readings of the temperatures of a rig); (5) “Life cycles”: such as the video/picture of a tree (or a mouse) over a long period of time; (6) Epidemiological health data: such as aggregate heart-rate or blood pressure data, infection rates; (7) Longitudinal data on populations detected movement within spaces (i.e. movement of an individual or individuals) for the purposes of health and/or sleep tracking; (8) Human-generated data, including but not limited to chat messages (on Skype™, Line™ Whatsapp™, Twitter, Facebook, WeChat™ QQ™ Weibo™), web pages, novels, film, video, images, scanned photos, paintings, Songs. Speeches, News accounts, news reporting.

Some implementations provide an interface such as an application on a smartphone operating system that provides a user-friendly interface in which the user will control their device's connection with the server, making choices as to which kinds of data the smartphone will upload, as well as any bandwidth limits. Much of the determination of what is uploaded is automatically computed.

Sensors gather many different types of data. In additional to referring to photos or videos, the word “image” often is used in the context of many other types of data, such as sonar data (“sonar images”), ultrasound data (“ultrasound images”), LiDAR data (“LiDAR images”). Further, there are technical practices that transform 1 dimensional data, such as audios, into 2 dimensional “images” so as to apply image analysis.

FIG. 5 illustrates systems and methods 1000 for devices collaborating in order to accomplish the goal of capturing concurrent, multiple perspectives of a target.

Step 1100 is where a device describes the target. The description including both characteristics innate to the target and those not innate to the target. Among the former group are the location, direction, size, sensed nature (such as its color, and whether it makes noise). Among the latter group includes the duration of the session of gathering data, the value of the target. The value of the target could originate from the initial information that kicks start the gathering, from the device, or from the collector.

Step 1120 is where the device ranks targets when there are at least two targets, so that the device can decide which target to focus on. First, whether two targets are compatible is evaluated, namely to a device, capturing an perspective of one target does not stop it from capturing an perspective of another target, for example, two targets are in similar positions within the viewfield of a video recording device, for another example, one target requires gathering of video and another target requires audio recording, which means a video recording device can serve both targets. Second, the device can rank targets based on to what extent the device can do a good job at capturing data. In one embodiment, ranking is done by weighted sum of scores for factors include the distance to the target, the feasibility of moving closer, and the device's remaining battery life.

Step 1200 is determining what types of sensory data are needed in order to do a good job capturing the perspectives of a target. One contemplated method is setting up a pre-determined knowledge base, which lists needed sensory data in a default setting as well as in enumerated knowledge. A contemplated default setting is for a device to request the same types of data that the device itself is capable of sensing. Another contemplated default setting is for the devices to capture as many types of sensory data as possible, some of these types are complementary in nature to what is being captured by device A. For example, when device A captures photos, complementary types include audio recording, GPS readings, speed readings, a sensor capturing air sample, and a sensor capturing text messages.

Some of the contemplated pre-determined enumerated knowledge includes: for a wedding, videos/images/sound recording are all needed; for a meeting, audio is satisfactory. Further, a human is allowed to supply such knowledge.

Step 1300 is solicitation of devices. A solicitation is initiated by the server, or by device A. The initiation by the soliciting party is referred to “triggering”. The solicitation is transmitted to the solicited party, such transmission can go through the server, or directly goes from the soliciting to the solicited. The solicited party can decide to agree to, disagree with, accept with contingency, ready to negotiate, or not respond. The solicited party can in turn initiate a solicitation, thus the solicitations form a cascade, referred to as “cascading triggers”; such triggers form a neighborhood of devices knitted by the triggers.

A solicitation contains requirements for availability, capacities, location, timing, and duration for gathering data by the solicited device. The solicitation can also contain proposed financial payments, or even promised punishment for rejection.

One contemplated solicitation contains request for gathering data by the solicited device at a specific location in a future time.

Step 1310 is where a solicitation is initiated. The solicitation can be initiated by the server, or by device A in FIG. 1. The server initiates a solicitation because (1) from time to time, devices update the server their location, distances, orientation, capabilities, timing, availability, and other characteristics; (2) the server based on the updates can decide automatically which device is gathering the most valuable data at the moment, and (3) the server decides which devices can be solicited to help, based on a utility function. The utility function is contemplated to assign a linear score to each of the location, distances, capabilities, availability of a device's. Many forms of the function are possible.

A solicitation can also be initiated by a device. A device is said to be performing “triggering” when it initiates soliciting of other devices. This occurs either through positive action by a human through a human-machine interface accessible the device, or automatically by an algorithm that utilizes sensors to identify an important event. The triggering device in one contemplated situation will activate all other devices within a defined range of users, physical area, and/or time (e.g. devices within 300 feet, and devices that are in that space within 30 seconds, or users that are connected to the triggering device's owner, but not necessarily within a given physical proximity, or all three). As a consequence, devices in vehicles can activate devices on pedestrians, and vice versa, and these triggers can have different standards for private groups or public access.

A trigger can be automatically generated, and some of the circumstances where a trigger is automatically generated are listed below: (1) significant deceleration or acceleration, 3Gs (about 30 m/s/s) is a threshold value, and a sensor for linear acceleration is preferred, (2) significant turning acceleration, (3) weaving or excessive lane changes, (4) traveling faster than X mph, (5) rolling stops, (6) violent cursing or expressions of fear, (7) texting on cellphone, (8) loud music, (9) meteors, and (10) sighting of a celebrity.

In one embodiment, a device while capturing data of a target, solicits a nearby device to capture “−M, +N seconds”, namely the solicitation asks the solicited device that the past M seconds of data is valuable, and if the device has such data, it should try to keep the data in face of limited storage, and also that the future N seconds is valuable, so the device within its capacities and availability should treat it as priority in capturing the future N seconds of data.

The length of M is contemplated to be decided in a number of methods.
(1) A predetermined length that a soliciting device knows a priori.
(2) The length is decided shortly before or after the soliciting, by the soliciting device, partially based on the usefulness score of the solicited device.
(3) The length is decided by the solicited device. The decision may consider a number of factors: (3a) going back in time, find the earliest piece of data that has a high enough relevance score, and mark that piece of data's time as −M. (3b) going back in time, calculate each piece of data's relevance score, and pick the earliest series of data that have an average relevance score that's high enough, mark the series' earliest time −M. (3c) using metadata of the target and the metadata of the solicited device to decide the earliest possible −M; For example, finding out the earliest time-space overlap of the target and the device, based on the metadata.
(4) The length that is negotiated between the two device, upon the soliciting.

In cascading solicitations, in a considered scenario, Device A detects a target which is a car driving in a wrong lane. The data that are gathered near the time of the crash is considered of high enough relevance. Then Device A solicits another device, Device B, informing Device B to preserve the previous 10 minutes' data (namely, “−M_B” is set to be −600 seconds). Device B in turn solicits another device, Device C, informing Device C to preserve the previous 20 minutes' data (namely, “−M_C” is set to be −1200 seconds).

Sometimes there are multiple solicitations, in which a device receives more than one solicitation, each asking for a different preservation length. For example, Device A solicits Device B and asks it to set “−M” to be −600 seconds, while a Device A′ in a next moment asks Device B to set “−M′ to be −1800 seconds; given the two solicitations, Device B sets “−M” to −1800 seconds.

The length of N is decided in ways parallel to how M is decided.

In addition, the length of N is partially dependent on the length of M, stemming from the intuition that if a device has good data in the past, the device might well be in the position of gathering good data in future; therefore a long M informs a long N. In addition to the methods in deciding N above, further contemplated methods are: (a) use M as the floor for N, namely, once the M of a device is decided, set an N that is >=M; (b) given an N that's decided using some of the methods, simply add M to obtain the final N.

Step 1320 depicts a method for a solicited device to process a solicitation, and for the soliciting device to try solicitation future in the situation where a solicited device is not willing to help. In this example, the solicited device can act in any of the following manners: (1) agrees to the solicitation; (2) agrees to the solicitation with contingency. Contemplated types of contingency include delays in availability, receipt of financial payments, and reduced quality in data gathering; (3) disagree to the solicitation; (4) disagree to the solicitation with contingency; (5) being silent to the solicitation, and (6) being silent to the solicitation with contingency.

Just like in Uber™, the soliciting party can try harder in solicitation. Some contemplated measures include: increasing financial payment to the owner of the solicited device, decreasing the demand on the availability of the device, and “blackmailing” the unwilling device with future uncooperative behavior.

Step 1360 is the creation of a neighborhood of devices by “cascading triggers”.

A stakeholder is the server or a device in FIG. 1. A neighborhood contains at least two stakeholders; the typical purpose of creating a neighborhood is for gathering data. The multitude stakeholders involved are called a neighborhood.

The server facilitates the creation of neighborhood in the following general steps: A stakeholder creates a trigger, a trigger being a command; and a trigger can be created manually by a person, or automatically by a device; the stakeholder is called the “prime stakeholder”. The trigger is sent, assisted by the server, to at least one another stakeholder. The stakeholders being sent the trigger is called neighbor to the prime stakeholder. The trigger received by a neighbor typically asks the neighbor to take an action, the action by default being data capturing.

A user (a pedestrian, for example, and perhaps a teenager or millennial) would want to create groups of their friends (perhaps different groups for different purposes) such that when they “activate” the group, then certain of the sensors on the smartphones of each of the members are automatically turned on by this user, and then they collectively engage in some experience or activity. So easy creation, acknowledgement of membership, and activation of these friend groups is desirable.

A neighbor in a neighborhood (without loss of generality called “the first neighborhood”) could initiate a trigger, thus becoming another “prime stakeholder”, reaching its neighbors, and thus forming a neighborhood (called “the second neighborhood”). A stakeholder might belong to both the first neighborhood and the second neighborhood. Still another stakeholder could initiate a trigger, creating the third neighborhood. More triggers can initiate, and more neighborhoods are created. The union of the neighborhoods might eventually reach all stakeholders, or in other cases, reach a subset of all stakeholders. This process can continue for a number of iterations defined in software and by individual users. Capping the number of triggers within a period of time helps to limit the number of nuisance triggers a hacker or an annoying person might generate.

Some of these triggers overlap in time, thus the following method is contemplated for managing the keeping of useful data on devices and possibly on the server. In one embodiment, when an event occurs (user-initiated, or initiated when certain conditions are met), a solicited device is asked to store −M and +N seconds of video, that is, M seconds of video before a specified time, and N seconds after that specified time. That much video is captured, and put into a store while the device still continues the looped video. This occurs both on the soliciting device and on the solicited devices. Now, it is possible for one of the solicited devices to initiate another solicitation requesting for a −M,+N capture which overlaps the first soliciting device's solicitation. In general up to K such solicitations can overlap. Each of these solicitation will be transmitted to the server as separate entities, and stored as such, i.e., as events of interest. Note that if all these −M,+N captures are done, all the captured videos are “relevant” since they are already grouped into the full set of relevant videos.

Such soliciting of devices is a form of resource sharing of communications, viz, dedicating an expensive resource (digital communication bandwidth, or an automobile, or a bedroom) which is almost never used, should be shared with others when the “owner” is not using it (message switching, packet switching, Uber, AirBnB™).

Step 1380 deals with contention during solicitation. For example, contention arises when there are 100 devices (D1-D100), and D1 and D10 each want to use competing sets of other devices.

The solutions involve a priority scheme. Parts of the priorities are set a priori, and other parts of the priorities are dynamic. Some priorities are built into the system, for example, ID assigned to each device. In general, there are four ways to revolve a contention, and all are contemplated for resolving the contention: (1) to queue, (2) to share, (3) to block and monopolize, and (4) to smash, as in two contenders collide, both fail, and try again after randomized time outs in the case of the Ethernet protocol. For more treatment on such priority schemes, see Priority Queueing in the book Queueing System by Leonard Kleinrock.

Step 1400 is a method in managing changes in membership in the neighborhood based on ranking of benefit of contribution. A member in the neighborhood is likely to be kept if its benefit of contribution is ranked high; a member is likely to be dropped if otherwise. Some of the ways of determination include: (1) if a device is too far away to achieve good quality in sensing, then the benefit is low, (2) if there are enough number of other devices contributing, an additional device will have low contribution. (3) financial payment being offered is ranked high, (4) rank high when different types of sensory data are asked for, for example, at a moment, an audio recording is needed to fill a blank, thus it ranks higher than a second video camera, (5) whether the device is able to maneuver to the better position, orientation, in order to capture the sensing data; in one contemplated scenario, the devices are not self-motive thus the devices cannot get to where the soliciting device wants them to go, for example, the owner of the phone is sleeping, or otherwise ignores instructions to move.

Step 1500 is where a device (or the server) gives advice to solicited devices on gathering additional perspectives. When device A solicits device B, a solicitation is provided with device B, and what is in the solicitation broadly falls into the category of location, setting for sensing, and utilization of capabilities. Once device B agrees to the solicitation and starts gathering data, device A can continually provide advice to device B; a piece of advice could be moving to another location, panning device B's camera, pointing the camera to certain directions, changing the settings of audio recording, increasing the frequency of sampling, among other possibilities.

In one contemplated embodiment, device A contains a software application which is capable of calculating a “difference value” of two images. Device A solicits device B, which provides images as an additional perspective of a target. Device A's software application calculates the difference value of the current image taken by itself and the current image taken by device B. Device A then advises device B to move to a new location in order to reduce the difference value.

In one preferred embodiment dubbed “sticks for 3D selfies”, a person holds 2 contemplated selfie sticks, each stick has a mobile phone mounted. A stick has a slider, and the mounted phone can move along the slider. A stick also is couple with a software application, thus is able to communicate with the phone to receive instructions on sliding motions. The person starts the first phone to take a series of selfie photos. While taking the photos, the first phone solicits the second phone, which agrees to the solicitation and also starts taking photos. The first phone advises the second phone on moving for certain amounts of distance, and the second phone instructs the slider on its stick to move the distance. After a period of time, the gathering of data is done, and the second phone sends photos to the first phone which acts at a collector. In an alternative embodiment, the second phone takes a video instead. In still another embodiment, the second stick is mounted a GoPro camera.

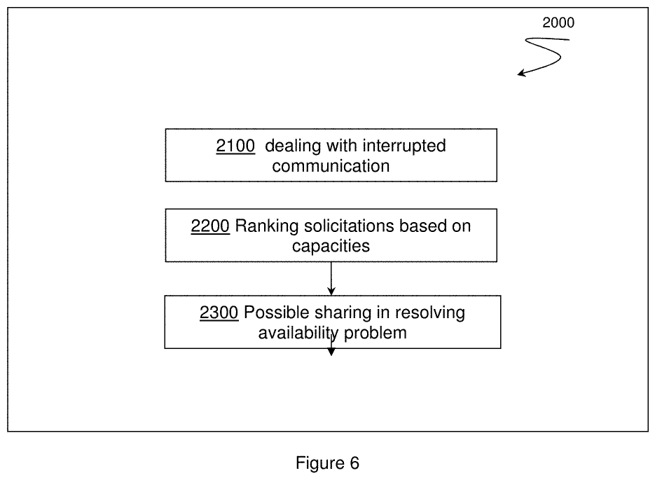

FIG. 6 are methods 2000 that collectively help a device deal with problems associated with its availability.

Step 2100 deals with interrupted communication. A device that has been in contact becomes not being able to be reached, or first reached and then lost, or reached in the middle of an event. If the device has completed the receipt of a solicitation, then it can proceed until the next moment when communication is needed for, for example, sending its own solicitation. If the device has not completed the receipt of the solicitation, then it can ignore it, and continue to do whatever it has been doing before the interrupted communication.

Step 2200 is ranking of solicitations based on the availability and capacities of the solicited device. Any of the capacities of the device can be a factor in ranking solicitations. This step works with Step 1380 above. The solicited device should provide its availability to the soliciting device, partially based on its then and anticipated capacities, in relation to expectations contained in the solicitation. For example, when battery is running out, the device cannot satisfy expected high resolution. For one example: the device's battery is running out in 5 minutes, however, the solicitation requires data expected to last only 1 minute, so this device should agree to the solicitation. Further, potential near-future emergence of solicitations should be considered, so that the device might be able to agree to the next solicitation with the remaining battery life.

Step 2300 considers sharing as a way of resolving contentious multiple solicitations. There are cases where the same device can satisfy multiple requests simultaneously, for examples, (1) the same device having multiple capabilities in audio, video, and images, and (2) the same video can serve two solicitations, both asking for the same chunk of video.

FIG. 7 are methods 3000 that collectively help a device deal with problems associated with its capacities.

Step 3100 manages battery life. For a typical device, when gathering data, the device is not plug in power, thus its battery supplies all the needed energy. All aspects of data gathering costs energy, and such costs are prioritized so that batter life can achieve more value. When battery is low, certain functions are turned off according to a priority list, for example, on the list Bluetooth is turned off before 3G is turned off.

Step 3200 applies to the case of an ad hoc network. A device could free up its local storage by transmitting its data onto another device on the ad hoc network.

Step 3300 contains methods of adaptively sending data to the collector.

Some of the solutions are implemented in the prototype system developed as a preferred embodiment of this invention.

Contemplated methods include: (1) when wi-fi is available, upload data in its full resolution to the collector; (2) when wi-fi is not available but data (3G, 4G, GPRS etc) is available, upload data in less resolution, and later upload the full resolution when wi-fi is available; (3) in streaming, when there are multiple devices streaming data to the collector, the collector allocates bandwidth according to perceived value of data from different devices; such ranking of value is first accomplished during solicitation, and the ranking can be modified by human intervention through a human-machine interface at the collector.

Some implementations provide an interface such as an application on a smartphone operating system that provides a user-friendly interface in which the user will control their device's connection with the server, making choices as to which kinds of data the smartphone will upload, as well as any bandwidth limits. Much of the determination of what is uploaded is automatically computed. Pre-processing, an optional step, creates metadata and data content from a piece of data. Typically, metadata is of small size, especially compared with “data content”. For example, from the data of an image, there could be created the metadata of the location, the maker of the camera, the timestamp, and the “data content” of pixels of the image. To facilitate finding relevant sensor data more findable, the system will combine locally produced metadata with other attributes suggested by the local device's user, as well as what it can infer from its own analysis of the data and that of nearby devices.

Some implementations contain: (1) software to easily upload sensor data from device to the server that storage, computation, and marketplace services. The smartphone case is an app available through application stores (e.g. Google Play™, Apple's App Store™). (2) an interface that allows the smartphone to connect over wi-fi or other internet access medium (i.e. Bluetooth) to the collector servers, and re-connect automatically with broken connection, and use public access points opportunistically, and (3) distributed triggering of sensor data to reduce bandwidth, storage, and processing requirements.

In addition to the intelligent determination of upload rates, some devices such as smartphones can store data locally and upload only when so requested to by the collector. Maximum rates of ongoing upload can be set by the device owner. When a potential customer notices or is involved in an event for which they would like to purchase pertinent pertaining data, they will inform the collector through a website, SMS system, or other easy method. (The more of these such notifications received for a single event, the more the collector will trust them.) Based on this notification the collector will instruct nearby devices to increase their upload rate, or, in the case of devices set to significant local storage, prioritize storage of data identified as significant by the notification to the collector.

With some implementations: (1) A car is not likely to be on the road for more than 1-2 hours per day before it reaches a point where it can find good connectivity (at home, in a garage, or at the office building), (2) The collector can make the frame rate dynamic based on: motion in the scene that the camera is recording, speed of the car itself, and this might reduce the frame rate to about an average of 3 fps; (3) the collector can cut down the resolution as well, also based on the two factors above (perhaps down to an average of 1 megabit/frame). The considerations above can cut down the bandwidth and storage from a pessimistic of 100 mbps and 360 Gbytes/hour by a factor of about 100 which gives: (i) 1 mbps, (ii) 3.6 Gbytes/hour, and also (iii) a daily storage requirement of about 7.2 Gbytes/day. However, there is another possibility that can be much more effective and it is the following: (a) one needs only send the metadata (location and time) of the vehicle up to the collector's database. This is a very small amount of data, (b) While that is going on, the camera is recording images based on the reduced requirements above, (c) However, the storage on the vehicle could overflow and write-over some earlier data and that might be data we need. So the collector needs to get the metadata up to the drone database quickly; and the methods include but are not limited to: (1) Whenever a car is in motion, that means that there is a driver in the car, and we know with very high probability that the driver has a connected cellphone with him/her that can talk to the cloud over their carrier network, (2) So all one has to do is to load an app on the cellphone as well as on the camera which allows them to talk with each other via Bluetooth, for example, (3) Then the metadata can be sent continuously from the sensor through the cellphone to the collector's database, (4) Now, when some buyer calls in The collector that they need some image data (e.g., they were involved in an accident), The collector's database is contacted, and the database sends a message to all sensors that have image data of interest (which the database can figure out using its AI capabilities), (5) The message tells each sensor of interest which portion of its captured data is should NOT overwrite, and (6) Then, the relevant data can be sent up immediately (using the cellphone access) or later when the drone gets within WiFi access.

The net result is that very little bit of the cellphone bandwidth is used to communicate (two-way) between the sensor and The collector database. Also, the sender only needs to upload images that have been requested and still handle the load.

There is no question that large volumes of data present difficulty even when bandwidth and processing power are growing exponentially over time. The “send me the track first” approach clearly is a start, and the collector can ask the user to store his/her video on YouTube first before the collector calls for the video. In addition, distributed computing can be employed, so that the user's phones do some computation while the data has not been uploaded yet. For legal issues in traffic accidents—a ‘fast’ phenomena that requires the collector to explain—5 fps (frames per second) would do. Also with some compression 5 megabits per frame is sufficient for upload. That alone makes the collector's data center much more doable. What, then, is the collector aiming for? There are at least two major areas: 1) events where people know they'll want a certain kind of viewable record, like a conference, and 2) the minimum amount of information required to have reliable understanding of an event. In the latter case, the “5 fps×5 megabits per frame” estimation is reasonable. The other thing to consider is that the collector has intelligent control of how much is uploaded, and how much the upload is compressed. A lot of this can use local processing. (This is reminiscent of the ‘triggering’ that had to be done extensively in high energy physics in the 1970s and 1980s, where data had to be removed before it was even recorded, because so much was being generated so fast.) Below are two examples of how that might work, the “semi-smart” and the “really smart”: (1) The semi-smart: if there's no movement or change in input at all in a frame, the device can, with instruction from The collector cloud, drop its upload to 0.5 fps and a low resolution. Scenes with zero movement, especially during low traffic periods at night, are a place where it can save huge bandwidth and processing, and help subsidize active areas. Same with when the audio drops to just background noise, or a heart rate is constant; (2) The really smart: this relates to Google's PageRank, but for multiple types of data and multiple types of relationship. Consider a single data source that is linked by time, location, or other metadata attributes to four other sources. If the four other sources are highly active, but for some reason the data source in consideration isn't, then this fact gives the collector a reason to increase the bandwidth from it, the ‘rank’ of the nearby data would communicate to the collector that this node under consideration is, in fact, more important than it knows from its own data. Conversely, if a single node is telling the collector that it is very important, but linked nodes (other data sources) are claiming that it isn't very important, then the collector cloud can make it send less information. This points to a way developing trust in what nodes report in distributed routing.

Considerations for the storage of data and processed data include but are not limited to: (1) All data can be replicated and stored in distributed manner; (2) Metadata and content might not reside physically next to each other, (3) A piece of content might be turned into multiple segments; These segments do not necessarily reside physically next to each other, and (4) Physical locations of data (including all of the above) might be re-arranged from time to time, in order for better response time, savings on physical storage space, etc. For example, a large video often being inquired by people in New York City might be moved to a database that has the fastest response time to inquiries from New York City.

Data collected before and after the trigger (for example, M seconds before the trigger's time, or N second after the trigger's time) are typically considered has more value than otherwise.

Centrally, the collector can intelligently determine the value of a device's data, based on analysis of data attributes across the system. For example, the most frequently purchased data will have a range of attributes—location, distance from landmarks, amount of movement, time of day, etc.—that will allow the system to intelligently predict the value of the data that could be uploaded by a given device, and modify the upload rate based on that prediction. When data is not being uploaded, devices will still update the system with metadata attributes of what they are recording. Similarly, if nearby devices are, by their local knowledge, producing valuable data (for example, in a video feed they could be detecting a large amount of movement), the system could determine that a device near those other devices should begin uploading at a rate faster than its own determinations suggest.

FIG. 8 depicts the forming of an ad hoc network among devices where different devices use method 4000 of creating or joining an ad hoc network. With the method, devices could communicate directly with each to form ad hoc communication network, e.g., one of them has land line access or some other good connection, while others are all blocked from using cellular. The solution belongs to the general question how to form an ad hoc network; alternatively, one device acts as the hot spot.

Many methods have been proposed for setting up ad hoc communication networks for generic devices. Some of the methods can be used in implementing parts of method 4000. Step 4010 comprises providing the first device a way of communicating with the second device so that the two are communicating. Step 4020 comprises finding out whether device A and device B eventually will create a new network, or one of them joining an existing network.

Step 4030 comprises creating a new network that contains device A and device B only. Step 4040 comprises letting device A joining an existing network of which device B is part. During the setup and usage of the ad hoc network, the devices use any of its communication capabilities, some of which are explained in FIG. 4.

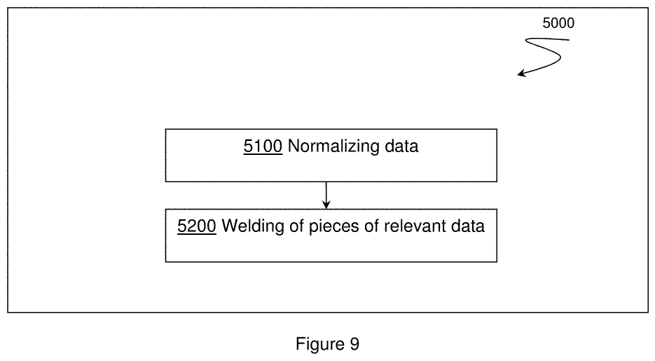

FIG. 9 illustrates the processing of data after data is gathered.

Step 5100 is normalization of time information and location information, e.g., solving problem caused by time delays cause problems when stitching together images and sound. Nowadays, all devices are synchronized (e.g., all synced to the Naval clock). If the devices are not synchronized, contemplated methods include: humans can help; cues/clues from the photos, sounds that mark the start of someone's talking, etc.

The normalized form for a piece of data, and the associated methods, are contemplated: (1) The location information contained in the metadata is being normalized so that the best possible resolution is obtained, and recorded in a form that is consistent across all location information. The methods include but are not limited to: converting all location information to the best possible GPS resolutions, converting all location information into the most accurate (x,y,z) coordinated in the space, computing the location information of a piece of data based on another pierce of data of known relationship (for example, the location of the first piece of data is precisely 1 meter forward on the z-axis to the location of the second piece of data, recognizing location information contained in the data content (e.g., the data content is an image captured by a satellite), (2) The time information contained in the metadata is being normalized so that the best possible resolution is obtained, and recorded in a form that is consistent across all time information. The methods include but are not limited to: converting the time information to the best possible precision, converting all time information into one particular format, computing the time information based on the time information of another piece of data when the time relationship between the two pieces of data is known, recognizing time information contained in the data content (e.g., the data content is an image and in the image there shows a clock); and (3) Additional metadata is normalized; the methods typically involve the using of the corresponding catalogs of the types of the metadata, and the standard vocabulary associated with such catalogs.

It has been contemplated a catalog of metadata, data content, processed data, the catalog includes but is not limited to: (1) Metadata and data content of a piece of data; (2) Metadata includes but is not limited to: the location information, the time information, types of data, information about the sensor, information about the environment of the sensor, information about the device, information about the speed of the device, information about the environments of the sensor, additional information on the history of how the data has been captured, stored, and transmitted. (3) The Spacetime model (reference: the Wikipedia page on “spacetime”) can be used in describing location information and time information. A “specific spacetime” can be a point or multiple points, a line or multiple lines, a plane or multiple plane, a region or multiple regions, or a set of the above. (4) Information or knowledge that is injected, deduced or otherwise created including but are not limited to ontology, knowledge base, updates to knowledge, knowledge created after machine learning; (5) Inquiries are also saved and stored on the server, and become data residing on the server. (6) Multiple types of sensor data is stored in The collector cloud with extensive metadata: (i) metadata such as modified exif tags that anonymize the metadata and incorporate it with user-created metadata and metadata our own algorithms create, with AI-assigned levels of trust, (ii) video footage comes with time and date stamp, as well as technical characteristics of video (frame rate, resolution), (iii) the collector can compare GPS data to topographical maps to get accurate elevation data, (iv) user optionally provides further information: what video is capturing, if there are people in the field of vision, flight path and estimated elevation if known (for drones); what the event is (similar to hash tagging), (v) The collector AI also performs content analysis and compares with user information (which is not necessary, but improves marketability of data), (vi) The collector scans for alphanumeric codes to search (license plates, signs, etc.) face density, speed of traffic, etc., (vii) The collector AI comes to decision about amount of people, type of scene, weather, amount of traffic, which alphanumeric codes in data, etc., (vii) all of this is coded into metadata, (viii) extensive metadata is used in making user easily searchable in new ways (detailed below in marketplace), (7) The data will not be anonymized in that the exif/metadata will be retained, however, the identity of the account holder will be protected; this will protect privacy and also prevent going outside of the collector to arrange cheaper payments, (8) As another related feature, since a device should be able to measure a vehicle's speed, then the frame rate of the camera could be adjusted to slow down when the vehicle is moving slowly. For example, when one stops to park on the street (or overnight) or in the apartment complex garage, then the frame rate could be dropped down to a minimum (providing garage or street protection) but not zero since it continues to act as surveillance. On the highway, it could go up to the 30 fps (note, a vehicle moving at 60 mph goes at 88 ft/sec, so 30 fps covers motion every 3 ft or so (but that is too high for city traffic). (9) A note on how general the data can be: A piece of data could be a scene from a novel, for example, a scene from the novel Ulysses contains metadata of location and time, and the location of a scene can well be related to a traffic condition occurring in today's Dublin.

Step 5200 is method for “welding” pieces of relevant data. Two pieces of data are welded if they fall in a specific spacetime, and this “welding” can be recursive.

Two pieces of data are candidates for being welded, because they are relevant in the following sense: based on the idea that one user/platform triggers nearby, or related platforms to capture data (and understand the “nearby” or “related” can mean that the triggered platforms need not be those that are within a certain distance of the source, but can be related some other way, such as in a common community, friends, etc., i.e., the definition of “distance” can be feet, cost, community, similarity, etc.

Two pieces of data collected through collative gathering by multiple devices are candidates for being welded. Irrespective of when the other devices are contacted to provide their additional perspectives, the devices can provide their information to the collector concurrently, or in any suitable sequence or time frame. Thus, it is contemplated that a dash cam on an automobile might “see” a car accident, and solicits additional perspectives from nearby dash cams. The various perspectives from the other dash cams can then be received by a collector, and then mosaicked by the collector or some other device. In another example, a cell phone being used by a participant in a birthday party might “see” someone blowing out a birthday cake, and solicit additional perspectives from nearby cell phones. Such solicitation might be initiated by the user of the soliciting cell phone, or might be initiated by the soliciting cell phone autonomously from its human user. As in the other example, the various perspectives from the various cell phones could then be received by a collector, and then mosaicked, stitched together in a 3D virtual reality image, or combined in some other manner by the collector or some other device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of target tracking, comprising:
forming an ad hoc network of smart Devices by detecting, by a Device A, a target, at a first moment in time t_1, the detecting being partly accomplished by analyzing a first data set collected by Device A; Device A becoming the first member of the network;
expanding the network, at a second moment in time t_2, by Device A soliciting Device B in that Device B is asked to preserve a second data set gathered M_B seconds (where M_B>=0) before t_2;
further expanding the network, at a third moment in time t_3, by Device B soliciting Device C in that Device C is asked to preserve a third data set gathered M_C seconds (where M_C>=0) before t_3; and wherein Devices A, B, and C form an ad hoc network.

2. The method of claim 1, further comprising, Device A at t_2′ (t_2′ is later than t_2) soliciting Device B in that Device B is asked to gather a fourth data set starting t_2′ for N_B seconds (where N_B>=0), and Device B at t_3′ (t_3′ is later than t_3) soliciting Device C in that Device C is asked to gather a fifth data set starting t_3 for N_C seconds where N_C>=0.

3. The method of claim 2, furthering comprising the ad hoc network detecting an additional target and tracking it.

4. The method of claim 3, furthering comprising, the first target being detected by Device A, and the second target being detected by a Device other than Device A.

5. The method of claim 2, further comprising, M_B and N_B being dependent.

6. The method of claim 1, further comprising, processing yielding metadata of the data, including but not limited to locating and registering the data relative to a Device, measuring significant characteristics of the data, a series of [x, y, z, t] where x, y, z is the three dimensional positions and t is time.

7. The method of claim 1, further comprising, processing of data including but not limited to enhancing quality of the data.

8. The method of claim 1, where the Devices are mobile.

9. The method of claim 1, further comprising, during the step of soliciting Device A considering the usefulness of Device B and the usefulness of a Device B′, and deciding not to solicit Device B′ partly because Device B′ has a low usefulness score to the ad hoc network.

10. The method of claim 9, further comprising, the usefulness of a Device to the ad hoc network is partly dependent on the relevance of the Device's data to the target.

11. The method of claim 1, furthering comprising, a Device being removed from the ad hoc network after the Device has a low usefulness score to the ad hoc network.

12. The method of claim 1, wherein the data analyzed and processed are data that are representative of a real scene, including obtained data of vehicles, people, places, things, drones, moving objects, or others.

13. The method of claim 1, wherein the data are representative of a scene in a virtual world, in an augmented realty world, in a video game, in a Metaverse, or others.
